(19) United States
(12) Patent Application Publication
(10) Pub. No.: US 2018/0258698 A1
(43) Pub. Date: Sep. 13, 2018

(54) Multifunction Ladder Stabilizer

(71) Applicant: Brian D. Minock, Hardy, VA (US)

(72) Inventor: Brian D. Minock, Hardy, VA (US)

(21) Appl. No.: 15/979,532

(22) Filed: May 15, 2018

Related U.S. Application Data
(63) Continuation of application No. PCT/US2016/055520, filed on Oct. 5, 2016.
(60) Provisional application No. 62/386,028, filed on Nov. 16, 2015.

(51) Int. Cl. E06C 7/48

(52) U.S. Cl. CPC E06C 7/482

(57) ABSTRACT

A multifunction stabilizer for attachment to a ladder includes: a frame including a base, a first arm connected to a first lateral side of the base and extending in a forward direction, a second arm connected to a second lateral side of the base opposite the first lateral side and extending in the forward direction, and a bracket-engagement member connected to the base and extending in a rearward direction opposite the forward direction; a rearward bracket including a base-engagement member, a first ladder-engagement wing extending from a first lateral end of the base-engagement member, and a second ladder-engagement wing extending from a second lateral end of the base-engagement member opposite the first lateral end; and a fastener for selectively locking the bracket-engagement member into engagement with the base-engagement member such that capture channels for receiving the rails of a ladder are defined between the arms and the ladder-engagement wings.

### CROSS-REFERENCE TO RELATED APPLICATION

This application is a continuation of International Patent Application Serial No. PCT/US2016/0055520, entitled “Multifunction Ladder Stabilizer,” filed Oct. 5, 2016, which claims the benefit of priority of U.S. provisional patent application No. 62/386,028, titled “Multi functioning stabilizer,” filed on Nov. 16, 2015, which is incorporated herein in its entirety by this reference.

### TECHNICAL FIELD

The present disclosure relates to devices for stabilizing a leaning ladder. More particularly, the present disclosure relates to a multifunction stabilizer for stabilizing a ladder upon a variety of structures including exterior corners, inside corners, trees and poles.

### BACKGROUND

Conventional ladders are typically only readily leaned with stability on a flat surface such as a wall. Interior and exterior corners represent a challenge with which workmen and homeowners are familiar. Trees and poles, especially in their variety of sizes, represent another familiar challenge. Free standing step ladders are inconvenient for some uses due to their footprint area. While some ladders have a small work shelf that hinges to a horizontal position when the ladder is leaned on a structure, such ladders don't have storage bins for tools and supplies. Typical ladder standoff devices are difficult to mount and remove from their host ladders, thus increasing set up and break down time when arriving and leaving from a job location.

Improvements in ladder accessories are needed, particularly with regard to providing safe and stable engagement with a variety of structures upon which a ladder can lean.

### SUMMARY

This Summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a multifunction stabilizer for attachment to a ladder includes: a forward frame including a central base, a first arm connected to a first lateral side of the central base and extending in a forward direction, a second arm connected to a second lateral side of the central base opposite the first lateral side and extending in the forward direction, and a bracket-engagement member connected to the central base and extending in a rearward direction opposite the forward direction; a rearward bracket including a base-engagement member, a first ladder-engagement wing extending from a first lateral end of the base-engagement member, and a second ladder-engagement wing extending from a second lateral end of the base-engagement member opposite the first lateral end; and a fastener system for selectively locking the bracket-engagement member of the forward frame into engagement with the base-engagement member of the rearward bracket such that a first capture channel for receiving a first rail of a ladder is defined between the first arm and the first ladder-engagement wing and a second capture channel for receiving a second rail of a ladder is defined between the second arm and the second ladder-engagement wing.

In at least one example, the first arm is laterally spaced from the second arm and a capture slot for receiving a structure is defined between the first arm and second arm.

In at least one example, at least one grip block is removably mountable on the forward frame within the capture slot. In at least one example, multiple grip blocks having multiple sizes are removably mountable on the forward frame within the capture slot. In at least one example, the first arm includes a first storage interior, and the second arm includes a second storage interior.

In at least one example, the first arm includes a bottom plate and a perimeter wall that extends upward from perimeter edges of the bottom plate, and the first storage interior is defined within the perimeter wall and above the bottom plate.

In at least one example, the first arm includes multiple interior ribs that divide the storage interior into multiple storage bins.

In at least one example, the forward frame further includes: a first ladder-engagement element connected to a rearward portion of the first arm; a second ladder-engagement element connected to a rearward portion of the second arm; first claws extending from the first ladder-engagement element; and second claws extending from the second ladder-engagement element.

In at least one example, the first capture channel is defined between the first ladder-engagement element and the first ladder-engagement wing; and the second capture channel is defined between the second ladder-engagement element and the second ladder-engagement wing.

In at least one example, the ladder-engagement elements of the forward frame are sloped at an offset angle relative to the central base and first and second arms; and the ladder-engagement wings are sloped at the offset angle relative to the base-engagement member.

In at least one example, the first and second ladder engagement wings are symmetric about the base-engagement member and each has laterally extending ridges and a saw-tooth profile.

In at least one example, at least one of the bracket-engagement member and base-engagement member has at least one slot for receiving a portion of the fastener system.

In at least one example, the fastener system includes threaded bolts; at least one of the bracket-engagement member and base-engagement member has slots for receiving the bolts such that the bolts slide within the slots permitting movement of the rearward bracket relative to the forward frame; and the fastener system further includes nuts for tightening upon the bolts to fix the position of the rearward bracket relative to the forward frame.

In at least one example, the slots of the base-engagement member are forward opening slots.

In at least one example, the forward frame includes at least one storage interior, and a removable cover for closure of the storage interior.

In at least one example, at least one bulb carrier is removably mountable on the forward frame, the bulb carrier having at least one hole for holding a light bulb.

In at least one example, the bracket-engagement member of the forward frame has a first contoured connection surface; and the base-engagement member of the rearward bracket has a second contoured connection surface for engaging the first contoured connection surface.

In at least one example, the first contoured surface has first laterally extending ridges; and the second contoured surface has second laterally extending ridges for engaging the first laterally extending ridges.

In at least one example, a first non-slip contact strip is applied to the first arm, and a second non-slip contact strip is applied to the second arm.

In at least one example, the forward frame and rearward bracket are each constructed at least in part of plastic mixed with glass fibers.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is an exploded perspective view of a multi-function stabilizer, according to at least one embodiment, for use with a ladder.

FIG. 2 is a perspective view of the multi-function stabilizer of FIG. 1 shown installed upon a ladder, according to at least one embodiment.

FIG. 3 is a side elevation view of the multi-function stabilizer of FIG. 1 shown with the forward frame separated from the rearward bracket, according to at least one embodiment.

FIG. 4 is a top view, looking downward, of the multi-function stabilizer and ladder of FIG. 2.

FIG. 5 is a perspective view of the multi-function stabilizer and ladder of FIG. 2 shown leaned upon an exterior corner of an architectural structure.

FIG. 6 is a bottom view of the multi-function stabilizer of FIG. 1.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

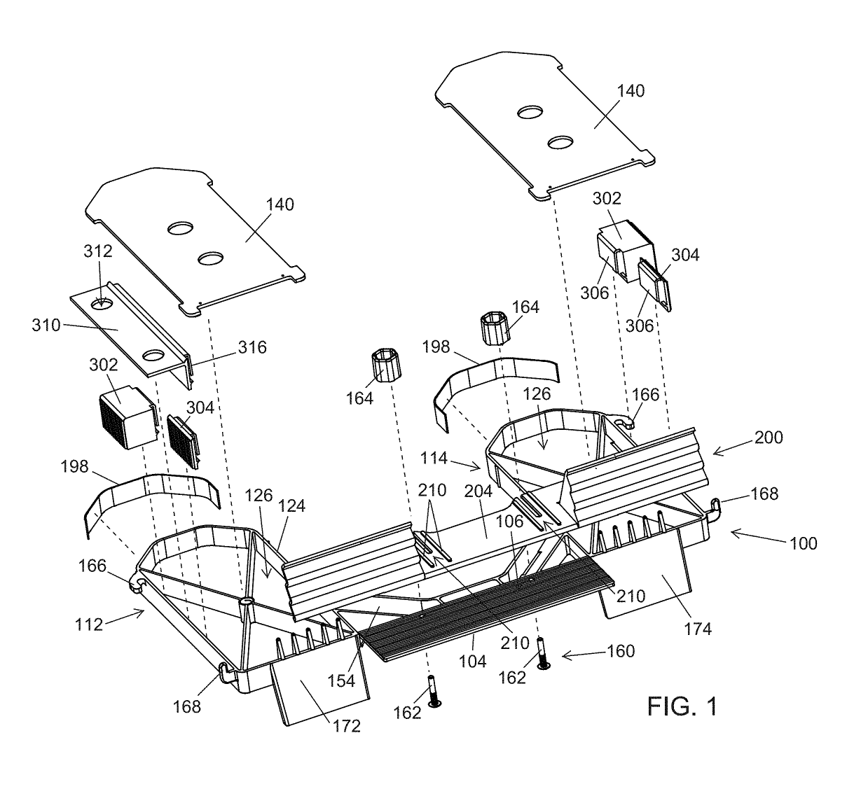

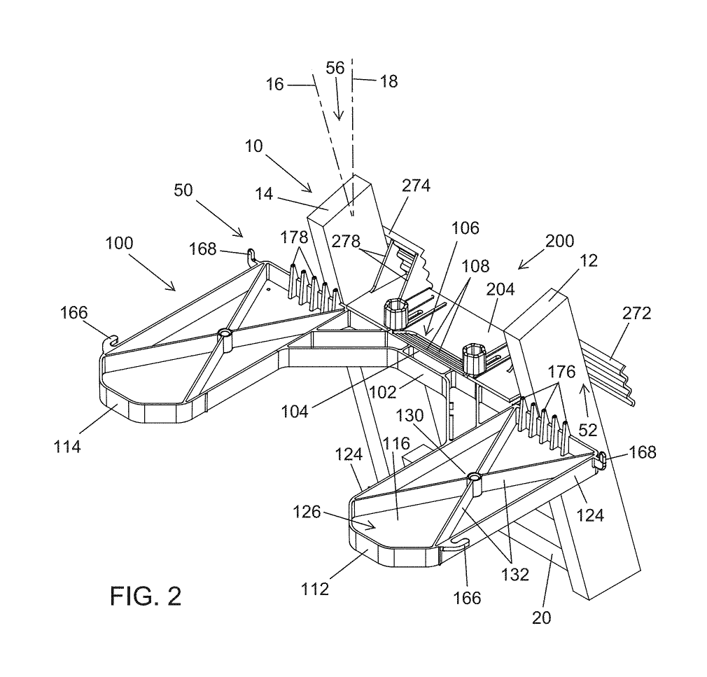

FIG. 1 is an exploded perspective view of a multi-function stabilizer 50, according to at least one embodiment, for use with a ladder 10. FIG. 2 is a perspective view of the multi-function stabilizer 50 of FIG. 1 shown installed upon a ladder 10. The multi-function stabilizer 50 has a forward frame 100 and a rearward bracket 200 that interconnect when the multi-function stabilizer 50 is assembled as shown in FIG. 2.

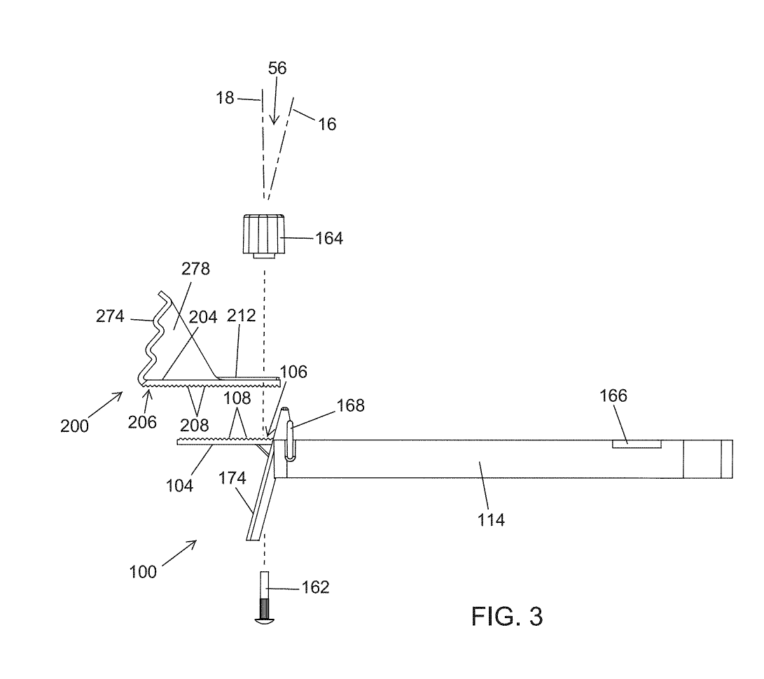

A brief description of the components of the ladder 10 will be useful in the subsequent descriptions of the multi-function stabilizer 50. A first rail 12, and a second rail 14 spaced from the first rail 12 extend parallel to a longitudinal axis 16. The first and second rails 12 and 14 can be described respectively as the left and right rails with respect to the perspective of a user climbing the ladder 10. Multiple rungs 20 interconnect the first and second rails 12 and 14. In typical safe use, the longitudinal axis 16 of a ladder 10 leans away from a gravity-defined vertical axis 18 as represented in FIGS. 2-3. The rungs 20 are typically approximately horizontal in use.

FIG. 3 is a side elevation view of the multi-function stabilizer 50 of FIG. 1 shown with the forward frame 100 separated from the rearward bracket 200, according to at least one embodiment. Forward and rearward are relative terms used herein for purposes of description refer to the perspective of a user mounting the ladder 10 with the rearward bracket 200 extending relatively toward the user and the forward frame 100 extending relatively away from the user. Furthermore for description purposes, features of the multi-function stabilizer 50 that extend generally parallel to the longitudinal axis of the ladder 10 are described herein as extending axially.

An expected arrangement for use of the ladder 10 and multi-function stabilizer 50 as shown in FIG. 2 permits a user to mount the first side of the ladder 10, face the forward direction, and ascend in an upward direction by climbing the rungs 20 of the ladder 10. Users may conceive other arrangements and uses and the ladder 10 and multi-function stabilizer 50 may be placed together or apart in arbitrary orientations when carried and stored. Nonetheless, such terms as forward, rearward, upper, lower, left and right and other relative terms are useful for descriptions of the multi-function stabilizer 50 and its features without ambiguity with reference to FIG. 2.

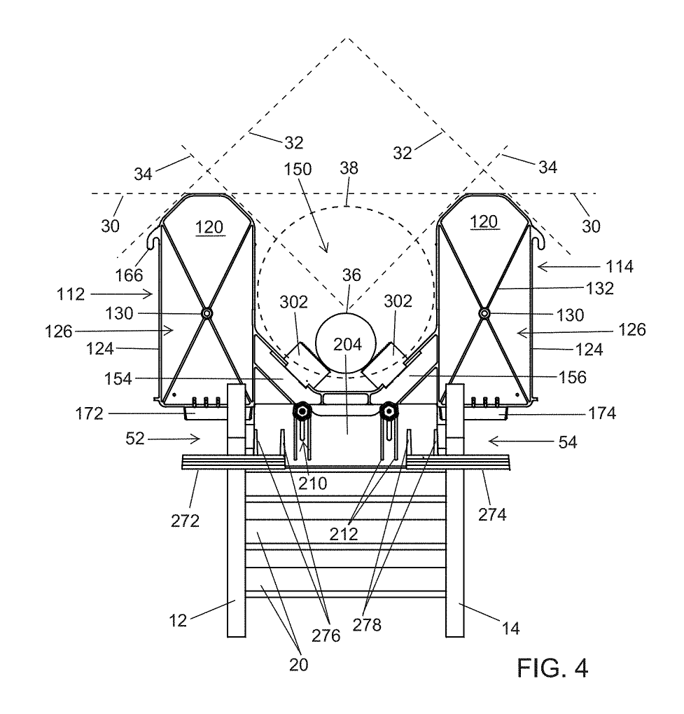

Advantages of the multi-function stabilizer 50 permit its use for leaning and support of the ladder 10 upon structures of many types, examples of which are represented in FIG. 4. The multi-function stabilizer 50 can support a ladder 10 leaning upon: a flat structure 30 such as the wall of a building; an inside corner structure 32; an outside corner structure 34; and poles, trees and other standing column-like objects of various diameter or dimensions as represented by structures 36 and 38 in FIG. 4. These are non-exhaustive examples.

In the illustrated embodiment (FIG. 2), the forward frame 100 of the multi-function stabilizer 50 includes a laterally central base 102. A bracket-engagement member 104 extends rearward from the base 102 for attachment to the rearward bracket 200. A first arm 112 and a second arm 114 extend forward from the base 102 of the forward frame 100. The laterally spaced first arm 112 and second arm 114 are connected to the first and second lateral sides of the base 102 and can be described as the left arm 112 and the right arm 114 with respect to the perspective of a user climbing the ladder 10.

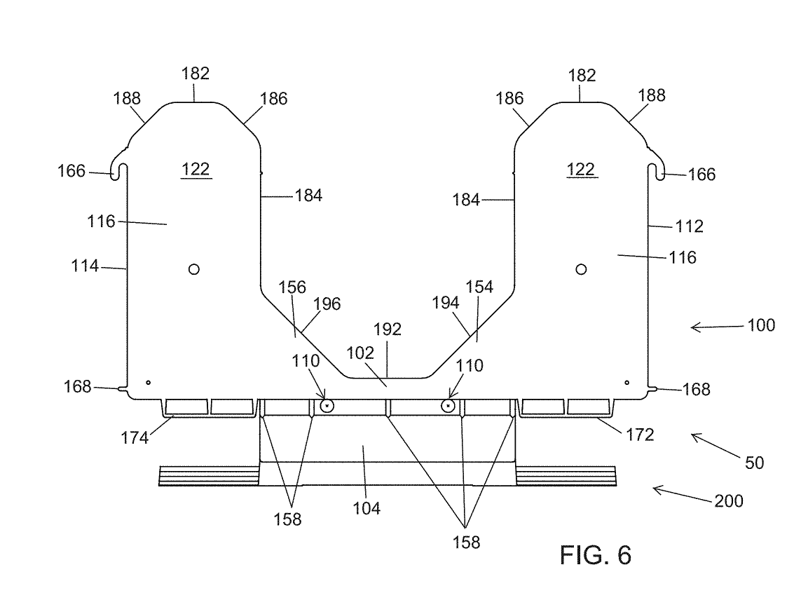

The first arm 112 includes a bottom plate 116 having an upper surface 120 (FIG. 4) and a lower surface 122 (FIG. 6). A perimeter wall 124 extends upward from perimeter edges of the upper surface 120 of the bottom plate 116 such that first arm 112 serves as an upward opening tray having a storage interior 126. A post 130 extends upward from the upper surface 120 of the bottom plate 116 and multiple interior ribs 132 extend from the perimeter wall 124 to the post 130. The ribs increase rigidity of the first arm 112 and divide the storage interior 126 into multiple storage bins. In the illustrated embodiment for example, four ribs 132 extend from respective portions of the perimeter wall 124 in a cross pattern that divides the storage interior 126 into four storage bins. A cover 140 (FIG. 1) serves as a removable lid of the first arm 112 for closure of the storage interior 126. The storage interior 126 is useful for storing tools, fasteners, hardware and any useful objects and supplies. The first and second arms 112 and 114 are symmetric about the central base 102 of the forward frame 100. Thus these descriptions of the bottom plate 116, perimeter wall 124, upper surface 120, lower surface 122, storage interior 126, post 130, ribs 132, storage bins, and cover 140 directed expressly to the first arm 112 at the left side of the base 102 apply as well to the second arm 114 at the right side of the base 102.

The first arm 112 and second arm 114 extend forward from the base 102 of the forward frame 100 such that a forward-opening capture slot 150 is defined forward of the laterally central base 102 and between the first arm 112 and the second arm 114. The base 102 includes, along a margin of the capture slot 150, a forward-extending first brace 154 connected to the first arm 112 along a rearward lateral portion of the first arm 112. Similarly the base 102 includes, along a margin of the capture slot 150, a forward-extending second brace 156 connected to the second arm 114 along a rearward lateral portion of the second arm 114. The first and second braces 154 and 156 increase the rigidity and strength of the forward frame 100. Furthermore, the first and second braces 154 and 156 advantageously taper the interior of the capture slot 150 at the rearward end of the slot.

As shown in FIG. 6, laterally spaced gussets 158 extend from the rearward end of the forward frame 100 to provide further strength and rigidity to the forward frame.

The bracket-engagement member 104 extends rearward from the base 102 for attachment to the rearward bracket 200. The rearward bracket 200 includes a corresponding base-engagement member 204 for attachment to the base 102. The bracket-engagement member 104 in the illustrated embodiment is a panel having a contoured upper connection surface 106. A corresponding contoured lower connection surface 206 of the base-engagement member 204 engages the connection surface 106 of the bracket-engagement member 104 in an adjustable relative position as shown in FIG. 2. A fastener system 160 locks the position of the rearward bracket 200 relative to the forward base 102 when a preferred position is reached. In the illustrated embodiment, the fastener system 160 includes threaded bolts 162 and corresponding nuts 164 for freeing and locking the engagement of the rearward bracket 200 relative to the forward base 102. As shown in FIG. 1, the threaded bolts 162 pass through holes 110 (FIG. 6) formed through the bracket-engagement member 104 of the forward base 102 and are received in corresponding forward opening slots 210 (FIG. 1) formed in the base-engagement member 204 of the rearward bracket 200. The rearward bracket 200 is then movable in forward and rearward directions relative to the base 102, as the bolts 162 slide within the forward and rearward extending slots 210, until the nuts 164 are tightened by turning so that the connection surfaces 106 and 206 (FIG. 3) engage and their relative positions are fixed. The nuts 164 in the illustrated embodiment are advantageously sized and shaped for hand turning by a user without additional tools. Raised guide bars 212 (FIGS. 3-4) extend forward and rearward along the top surface of the base-engagement member 204, one along each lateral side of each slot 210, and are parallel to the forward and rearward extending slots 210. The raised guide bars 212 increase strength and rigidity of the base-engagement member 204 particularly along the slots 210 where the fastener system 160 applies force upon tightening of the bolts 162 and nuts 164.

In particular, in the illustrated embodiment, the contoured connection surface 106 has spaced laterally extending ridges 108 (FIGS. 2 and 3) defining grooves therebetween. The contoured connection surface 206 has similarly or same-spaced laterally extending ridges 208 (FIG. 3) defining grooves therebetween. When the connection surfaces 106 and 206 engage in a preferred position, and a user locks the fastener system 160, the ridges of each connection surface engage and interlock with the ridges of the other connection surface for a non-slip engagement when the fastener system 160 locks.

The forward frame 100 and rearward bracket 200 include further features for fixing the installation of the multi-function stabilizer 50 upon the ladder 10. With regard again to the forward frame 100, a rearward facing first ladder-engagement element 172 is connected to forward frame 100 for engaging the first rail 12 of the ladder 10. In the illustrated embodiment the first ladder-engagement element 172 is connected to a rearward portion of the first arm 112. Similarly, a rearward facing second ladder-engagement element 174 for engaging the second rail 14 of the ladder 10 is connected to the forward frame 100 by connection to a rearward portion of the second arm 114. Several laterally spaced first claws 176 each extend axially upward from the upper edge of the first ladder-engagement element 172 to further engage the first rail 12 and particularly prevent rotation of the ladder 10 relative to the multi-function stabilizer 50. Similarly, several laterally spaced second claws 178 each extend axially upward from the upper edge of the second ladder-engagement element 174 to further engage the second rail 14 and particularly prevent such rotation.

With regard again to the rearward bracket 200, a first ladder-engagement wing 272 is connected to and extends laterally from the left end of the base-engagement member 204. Similarly, a second ladder-engagement wing 274 is connected to and extends laterally from the right end of the base-engagement member 204. Two upwardly extending braces 276 (FIG. 4) further connect the first ladder-engagement wing 272 to the base-engagement member 204 of the rearward frame 200. Similarly, two upwardly extending braces 278 (FIG. 2-4) further connect the second ladder-engagement wing 274 to the base-engagement member 204 of the rearward frame 200.

When the multi-function stabilizer 50 is assembled as shown in FIG. 2, a first capture channel 52 for receiving the first rail 12 of the ladder 10 is defined between the first ladder-engagement wing 272 of the rearward bracket 200 and the first ladder-engagement element 172 of the forward frame 100. Similarly, a second capture channel 54 for receiving the second rail 14 of the ladder 10 is defined between the second ladder-engagement wing 274 of the rearward bracket 200 and the second ladder-engagement element 274 of the forward frame 100.

The first and second ladder 10 engagement wings are symmetric about base-engagement member 204 in the illustrated embodiment. Each of the first and second ladder-engagement wings 272 and 274 has laterally extending ridges and has a saw-tooth profile when viewed from a lateral side as in FIG. 2. This feature strengthens the ladder-engagement wings 272 and 274 and improves grip upon the ladder 10.

In typical use, the longitudinal axis 16 of a ladder 10 leans away from the gravity- defined vertical axis 18 as represented in FIGS. 2-3. A lean angle 20 is defined between the longitudinal axis 16 and vertical axis 18. Actual lean angle can vary with each use according to the arrangement a user establishes. The ladder-engagement wings 272 and 274 of the rearward bracket 200 are sloped relative to the base-engagement member 204. Similarly, the ladder-engagement elements 172 and 174 of the forward frame 100 are sloped relative to the base 102 and first and second arms 112 and 114. In particular, the ladder-engagement wings 272 and 274 and the ladder-engagement elements 172 and 174 are sloped at a particular offset angle 56 so as to maintain the base 102 and first and second arms 112 and 114 as approximately horizontal relative to the gravity-defined vertical axis 18 when the multi-function stabilizer 50 is installed upon a ladder 10 leaned at a lean angle approximately equal to the offset angle 56.

To briefly summarize installation of the multi-function stabilizer 50 upon a ladder 10, the forward frame 100 and rearward bracket 200 are detached and placed on opposing sides of a ladder 10 with the ladder-engagement wings 272 and 274 and ladder-engagement elements 172 and 174 facing the rails of the ladder 10. The base-engagement member 204 of the rear bracket 200 and the bracket-engagement member 104 of the forward frame 100 are extended through the ladder 10 between the rails 12 and 14 bringing the forward frame 100 and rearward bracket together as shown in FIG. 2. When a preferred position is reached with the ladder-engagement wings 272 and 274 and ladder-engagement elements 172 and 174 abutting the rails of the ladder 10, the fastener system 160 is locked. This applies clamping force upon the rails of the ladder 10 in the capture channels 52 and 54 and the multi-function stabilizer 50 clamps upon the ladder 10. In the illustrated embodiment, the threaded bolts 162 and corresponding nuts 164 can be conveniently carried by the forward frame 100 throughout installation and removal of the multi-function stabilizer 50 without removing the nuts from the bolts due to the advantage of the forward opening slots 210 formed in the base-engagement member 204 of the rearward bracket 200.

The multi-function stabilizer 50 and ladder upon which the stabilizer is installed can be leaned against a structure simply by contacting the forward ends of the arms 112 and 114 against the structure. However, the first and second arms 112 and 114 have multiple contact surfaces for improved range of use when leaning a ladder 10 upon diverse types of structures. In the illustrated embodiment, as shown for example in FIG. 6, the forward end of each arm has a forward exterior contact surface 182 facing forward, a lateral interior contact surface 184 facing into the capture slot 150, an inwardly angled interior contact surface 186 between the perpendicular forward exterior contact surface 182 and lateral interior contact surface 184, and an outwardly angled exterior contact surface 188 perpendicular to the inwardly angled interior contact surface 186. Interior and exterior refer here to the disposition of each contact surface with respect to the capture slot 150.

The forward end of the base 102 of the forward frame 100 has additional multiple forward contact surfaces for improved range of use when leaning a ladder 10 upon diverse types of structures. In the illustrated embodiment, as shown for example in FIG. 6, the base 102 has a central forward interior contact surface 192, and a pair of inwardly angled interior contact surfaces 194 and 196 along the forward edges of the first and second braces 154 and 156 between the interior contact surface 192 and lateral interior contact surfaces 184.

As shown in FIG. 1, non-slip contact strips 198 are applied to the contact surfaces 182, 186 and 188 to provide traction or grip when the multi-function stabilizer 50 and ladder 10 are leaned upon the contact surfaces and non-slip contact strips 198. The contact strips 198 are expressly illustrated as applied to the forward ends of the first and second arms 112 and 114. Contact strips applied elsewhere, such as upon all described contact surfaces, are within the scope of these descriptions.

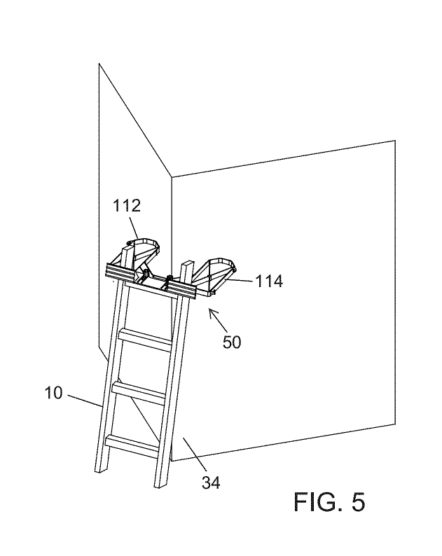

FIG. 4 is a top view, looking downward, of the multi-function stabilizer and ladder of FIG. 2. As previously briefly described, the multi-function stabilizer 50 can support a ladder 10 leaning upon: a flat structure 30 such as the wall of a building; an inside corner structure 32; an outside corner structure 34; and poles, trees and other standing column-like objects of various diameter or dimensions as represented by structures 36 and 38 in FIG. 4. These are non-exhaustive examples. For example, the multi-function stabilizer 50 can support a ladder 10 leaning upon poles, trees and other standing column-like objects of greater diameter or dimensions than that represented of structures 36 and 38. Each of the structures represented in dashed lines in FIG. 4 represent a respective three-dimensional structure. For example, the multi-function stabilizer 50 and ladder 10 shown leaned upon the outside corner structure 34 in the perspective view of FIG. 5.

For some examples of use, the multi-function stabilizer 50 provides stand-off distance between the ladder 10 and the structure on which the multi-function stabilizer 50 and ladder 10 are leaned. For example, the ladder 10 in the illustrated arrangement of FIG. 4 is spaced from the flat structure 30 by a stand-off distance that is approximately the forward length of the first and second arms 112 and 114. Stand-off distance permits a working area, for example above the forward frame 100, and is preferred by some users.

The first and second braces 154 and 156 advantageously taper the interior of the capture slot 150 at the rearward interior end of the capture slot. Thus the multi-function stabilizer 50 tends to center upon and better engage for example poles, trees or standing column-like objects.

The multi-function stabilizer 50 includes removable grip blocks 302 (FIGS. 1 and 4) for installation within the capture slot 150, for example by mounting upon the inwardly angled forward edges of the first and second braces 154 and 156. The grip blocks 302 facilitate stabilization upon, for example, smaller structures that would otherwise be received deeply within the capture slot 150. In the illustrated example of FIG. 4, grip blocks 302 are shown engaging a smaller pole, tree or other standing column-like object as represented by the structure 38. The grip blocks 302 also increase the effective stand-off distance. In the illustrated embodiment of FIG. 1, a first exemplary grip block 302 and a second exemplary grip block 304 are shown as having different sizes. Same-sized grip blocks are preferably provided in pairs to symmetric installation within the capture slot 150.

Each grip block has an engagement member 306 such as a clip for engaging a selected portion of the forward frame 100. In FIG. 4, the grip blocks 302 are clipped onto the forward perimeter wall 124 of the base 102 that defines the central forward interior contact surface 192. The grip blocks 302 and 304 can be stored by clipping them onto the outer perimeter wall 124 of the first arm 112 or second arm 114 as represented in FIG. 1.

The multi-function stabilizer 50 includes a removable bulb or tool carrier 310 having holes 312 for holding light bulbs, tools, or other objects as needed or preferred by a user. The carrier 310 has an engagement member 316 such as a clip for engaging a selected portion of the forward frame 100. The carrier 310 can for example be mounted on the outer perimeter wall 124 of the first arm 112, as represented in FIG. 1, or second arm 114. The carrier 310 can be loaded with bulbs for example when replacements are needed in high places such as raised flood light fixtures.

The storage interiors 126 of the first and second arms 112 and 114 and the carrier 310 permits the user to load needed items onto the multi-function stabilizer 50 before ascending a ladder thus facilitating a safe climb by the user. The storage interiors 126 or the covers 140 mounted over the interiors 126 can serve as working areas. The covers 140 may be tethered or otherwise coupled to their respective arms 112 and 114 to prevent loss of the covers 140 when the storage interiors 126 are to be accessed.

FIG. 6 is a bottom view of the multi-function stabilizer 50 of FIG. 1. As shown in FIGS. 2 and 6, the multi-function stabilizer 50 includes retaining hooks 166 for temporarily attaching the stabilizer structures. See structures 36 and 38 in FIG. 4 for example. As shown in FIGS. 1 and 6, retaining hooks 166 extend outwardly from the lateral sides of the arms 112 and 114 and hook rearward. The retaining hooks 166 can be used to tether the multi-function stabilizer 50 and ladder to structure such as poles, trees and other standing column-like structures by passing a cord or bungee around the structure and hook or otherwise fix the ends of the cord or bungee to the retaining hooks 166. The retaining hooks 166 can be used to tether the multi-function stabilizer 50 and ladder to other types of structure where anchor points or other attachments facilitate use of the hooks.

As shown in FIGS. 1 and 2, at least one hanger hook 168 extends outwardly from each outer lateral side of the arms 112 and 114 and hooks upward. The hanger hooks 168 can be used for hanging tools, flashlights, electrical cords, and other items.

In at least one embodiment, the forward frame 100 and rearward bracket 200 are formed of plastic and are injection molded. For example, the forward frame 100 and rearward bracket 200 are each formed of polypropylene (plastic) mixed with glass fibers so as to be strong but not brittle, allowing some flexibility while in use. The forward frame 100 and rearward bracket 200 are electrically non-conductive in such embodiments to permit safe use around electricity including power tools and electrical lines. The grip blocks 302 and 304, bulb or tool carrier 310, and covers 140 can be similarly formed.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A multifunction stabilizer for attachment to a ladder, the multifunction stabilizer comprising:
a forward frame including a central base, a first arm connected to a first lateral side of the central base and extending in a forward direction, a second arm connected to a second lateral side of the central base opposite the first lateral side and extending in the forward direction, and a bracket-engagement member connected to the central base and extending in a rearward direction opposite the forward direction;
a rearward bracket including a base-engagement member, a first ladder-engagement wing extending from a first lateral end of the base-engagement member, and a second ladder-engagement wing extending from a second lateral end of the base- engagement member opposite the first lateral end; and
a fastener system for selectively locking the bracket-engagement member of the forward frame into engagement with the base-engagement member of the rearward bracket such that a first capture channel for receiving a first rail of a ladder is defined between the first arm and the first ladder-engagement wing and a second capture channel for receiving a second rail of a ladder is defined between the second arm and the second ladder-engagement wing.

2. The multifunction stabilizer of claim 1, wherein:
the first arm is laterally spaced from the second arm and a capture slot for receiving a structure is defined between the first arm and second arm.

3. The multifunction stabilizer of claim 2, further comprising at least one grip block removably mountable on the forward frame within the capture slot.

4. The multifunction stabilizer of claim 2, further comprising multiple grip blocks having multiple sizes, the multiple grip blocks removably mountable on the forward frame within the capture slot.

5. The multifunction stabilizer of claim 1, wherein the first arm includes a first storage interior, and the second arm includes a second storage interior.

6. The multifunction stabilizer of claim 5, wherein the first arm includes a bottom plate and a perimeter wall that extends upward from perimeter edges of the bottom plate, and the first storage interior is defined within the perimeter wall and above the bottom plate.

7. The multifunction stabilizer of claim 6, wherein the first arm includes multiple interior ribs that divide the storage interior into multiple storage bins.

8. The multifunction stabilizer of claim 1, wherein the forward frame further includes:
a first ladder-engagement element connected to a rearward portion of the first arm;
a second ladder-engagement element connected to a rearward portion of the second arm;
first claws extending from the first ladder-engagement element; and
second claws extending from the second ladder-engagement element.

9. The multifunction stabilizer of claim 8, wherein:
the first capture channel is defined between the first ladder-engagement element and the first ladder-engagement wing; and
the second capture channel is defined between the second ladder-engagement element and the second ladder-engagement wing.

10. The multifunction stabilizer of claim 8, wherein:
the ladder-engagement elements of the forward frame are sloped at an offset angle relative to the central base and first and second arms; and
the ladder-engagement wings are sloped at the offset angle relative to the base-engagement member.

11. The multifunction stabilizer of claim 1, wherein the first and second ladder engagement wings are symmetric about the base-engagement member and each has laterally extending ridges and a saw-tooth profile.

12. The multifunction stabilizer of claim 1, wherein at least one of the bracket-engagement member and base-engagement member has at least one slot for receiving a portion of the fastener system.

13. The multifunction stabilizer of claim 1, wherein:
the fastener system includes threaded bolts;
at least one of the bracket-engagement member and base-engagement member has slots for receiving the bolts such that the bolts slide within the slots permitting movement of the rearward bracket relative to the forward frame; and
the fastener system further includes nuts for tightening upon the bolts to fix the position of the rearward bracket relative to the forward frame.

14. The multifunction stabilizer of claim 1, wherein the slots of the base-engagement member are forward opening slots.

15. The multifunction stabilizer of claim 1, wherein the forward frame includes at least one storage interior, and a removable cover for closure of the storage interior.

16. The multifunction stabilizer of claim 1, further comprising at least one bulb carrier removably mountable on the forward frame, the bulb carrier having at least one hole for holding a light bulb.

17. The multifunction stabilizer of claim 1, wherein:
the bracket-engagement member of the forward frame has a first contoured connection surface; and
the base-engagement member of the rearward bracket has a second contoured connection surface for engaging the first contoured connection surface.

18. The multifunction stabilizer of claim 17, wherein:
the first contoured surface has first laterally extending ridges; and
the second contoured surface has second laterally extending ridges for engaging the first laterally extending ridges.

19. The multifunction stabilizer of claim 1, further comprising a first non-slip contact strip applied to the first arm, and a second non-slip contact strip applied to the second arm.

20. The multifunction stabilizer of claim 1, wherein the forward frame and rearward bracket are each constructed at least in part of plastic mixed with glass fibers.
